(19) United States
(12) Patent Application Publication
(10) Pub. No.: US 2008/0134991 A1
(43) Pub. Date: Jun. 12, 2008

(54) Ergonomic animal suspender harness vest

(76) Inventor: Lynn Miriam DePass, Farmers Branch, TX (US)

Correspondence Address: LYNN M. DEPASS, 2615 MOUNT VIEW DR., FARMERS BRANCH, TX, 75234, US

(21) Appl. No.: 11/635,574

(22) Filed: Dec. 8, 2006

(51) Int. Cl. A01K 27/00

(52) U.S. Cl. 119/856

(57) ABSTRACT

An animal suspender vest harness controls and provides protection from the elements at the same time. This one piece design has a wide band, starting mid-chest, extending around the ribcage. From this a mid portion, extending to the shoulders, with right and left suspender straps extending over the shoulders, criss-crossing diagonally at mid-chest, attaching to the bottom of the ribcage band., where they all connect together. Top center of the ribcage band, is an opening with a connection strap, holding a D-ring to attach a leash. The ergonomic criss crossing suspender strap design, provides a uniformed pressure distribution across the bony structures of the animal only, without applying pressure to the unprotected neck. Additionally, with elastic built into the shoulder areas and the connecting ring strap, along with the wideness of the vest, reduces's the force placed on the animal, and dissipates it across a larger surface area.

### FIELD OF THE INVENTION

The present invention relates to an ergonomically designed device, more particularly suited for small domestic animals, that controls and restrains while providing protection from the elements at the same time. More particularly to a one piece harness vest that is releasable secured to the animal, with suspender straps criss crossing each other diagonally at mid chest, and attaching to the bottom ribcage band on the opposite side from the shoulder it crossed, so as to distributes the forces across bony structures only (shoulders, chest, and rib cage), while preventing injury to the soft tissue of the neck and/or trachea area.

### BACKGROUND OF THE INVENTION

Since the dawn of time, there has existed a need to restrain and control animals. In the beginning, these devices were crude and task-oriented, with little regard to the animal's comfort. As time passed, and we became a more developed, civilized society, with domestic pets, the restraining and controlling devices, evolved as well. Today, comfort, safety, and style are main priorities for owners. Almost all of the devices that fit this bill, are the typical neck collars and harnesses. The harnesses basically have a neck strap, a ribcage strap, and a third strap connecting the two, either on the top or on the bottom of the animal. If this connecting strap is on the top, it has a ring connected to it for the leash, tether, and/or lead to attach; if it's on the bottom, the ring for the leash is on the top of the ribcage strap. The ribcage strap entirely encircles the ribcage and the neck strap entirely encircles the animal's neck. When the connection strap is on the top, and the animal struggles against the leash, tether, and/or lead, both the ribcage strap and third strap are pulled backwards, which in turn, pulls the neck strap back, causing it to rise up and put pressure on their neck, until they stop pulling. If the connection strap is on the bottom, it pulls the animal's head down until it stops. Additionally, they go over the animal's head, and most, if not all animals do not like this, making it harder for the owners to put on them. The neck collar is one strap that entirely encircles the animal's neck and functions like the harness, in that when pulled, it puts pressure on the animal's neck and/or throat until they stop. More recently, a harness made like a vest, has come out on the market, which replaces all of the straps, and closes with Velcro R.T.M., around both the neck and ribcage The principles are the same and it functions like the harness, putting pressure on the throat. However, the wider vest replaces the more narrow straps, so the force is dissipated over a larger surface area. Further, the above designs provide little or no protection from the elements.

These devices range from simple neck collars, to harnesses's with releasable straps encircling the neck and/or body, to fancier vest-like harnesses, not to mention, the more elaborate configurations consisting of a plurality of loops with tightening principles and leashes built in, as described in U.S. Pat. Nos. 2,247,905, 4,060,056, 3,768,445, 2,826,172, 4,501,30B1, 5,911,200, 5,743,216, 5,511,515, 2,187,021, 6,401,666. However, none of these provided protection from the elements at the same time. Most recently, on May, 4, 2006, an application (20060090711) was filed by Ruth E. Richards, requesting an utility patent for such a design. The harness, consisting of a neck strap, a ribcage strap, and a strap connecting the two. This is connected to the bottom of a coat. However, the neck strap entirely encircle the animals neck.

The primary disadvantage to the collar and harness designs described above, in particular for the smaller animals, is the inability to remain properly fitted, when they struggle against the leash, tether, and/or lead. The results can range from simple discomfort to the neck, to more serious injuries, not to mention dangerous, if they escape and run free. Escaping happens most frequently with the single strap collar designs. With the more complicated harness and/or multiple loop configurations, they get entangled more frequently. Most basically include a strap that encircles the animal's neck entirely, and designed such that, when the animal pulls against the leash, tether and/or lead, the strap either rides up the neck of the animal, putting pressure on their throats, or the straps pull their heads down until the animal stops. This can result in choking, or a more serious injury to their neck and/or trachea, because, unlike humans, small animals do not have a collar bone in front to protect their necks, only shoulder blades in the back. This is particularly true for the tiny teacup, teacup, and tiny toy sizes, that have become so popular as of late. Also, the straps go over the animal's head, making it difficult to put on, as they do not like anything going over them. The vest harnesses also entirely encircles the animal's neck, causing similar problems, except the vest has a larger surface area to dissipate the forces across, so the pressure is not as great as the smaller straps of the traditional harness's mentioned above. Also, the neck strap of the harness vest, if pulled hard enough against, tends to open, leaving only the ribcage band connected to the animal.

Further, these controlling devices provide little (vest), if no protection from the elements, resulting in the need to purchase a second garment to wear over it. Not only does this garment have to be large enough to fit, but have an opening on the top, long enough for the leash to pass through, and connect to the restraining and controlling device. More frequently than not, the opening of the larger garment, does not match up with the connecting ring on the harness or collar. So when the animal pulls against the leash, tether, and/or lead, the protective garment slides backwards. At best, it comes loose, or worse, chokes the animal. Thus there exists a need for a restraining and controlling device for animals, that combines style, comfort, safety, and protection from the elements, all in one garment, and is not made with a head strap that entirely encircles their neck applying pressure until they stop.

It is therefore an object of the invention to provide a restraining and controlling device that is safe, comfortable and stylish.

It is another object of the invention to provide a device that is easy to put on and neither goes over the head or entirely encircles the animal's neck.

It is therefore an object of the invention to provide a restraining and controlling device, that transmits the force across bony structures only.

It is another object of the invention to provide one garment that controls and restrains animals, while protecting them from the elements at the same time.

### SUMMARY OF THE INVENTION

A suspender vest harness for animals, is one garment that restrains, controls, and provides protection from the elements at the same time. This two layered design is, one continuous piece of material, with seams on the outer edges only, making it very durable. It consists of a wide ribcage band with right and left sides, starting mid back, and extending down around the ribcage, where it's releasably secured to the animal. Continuing from this band, is a mid portion, covering the upper back, and extending to the top of the shoulders, with right and left suspender straps extending over the shoulders, criss-cross each other diagonally at mid-chest, and attaching to the bottom of the ribcage band on the opposite side from the shoulder they crossed. The suspender straps connect to, and sandwiched between, the right and left sides of the ribcage bands, with wide, long, hook and loop fasteners, making it extremely difficult to come apart. In the middle of the top of the ribcage band, there is an opening with a small strap extending from the top, holding a ring, for the leash, tether, and/or lead to attach. With this feature, the connecting ring strap can move freely and be used from either side, and being made with two finished layers, this device is completely reversible. The “wideness” of the garment, and the ergonomically designed criss crossing suspender straps, dissipate the forces across a larger surface area and across the bony structures of the ribcage, shoulder blades, and chest only, respectively, and not the sensitive areas of the neck, as so many other devices do. Additionally, elastic is built into the suspender straps and the connecting ring strap, to further reduce the remaining force placed on the animal. The elastic and wide long fasteners allows for a great range of adjustability as well. The size of the criss crossing suspender strap harness design can range from a bikini, to a vest, and to long coat.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a perspective view of the front and back sides of the suspender vest harness, as it's completely reversible, in accordance with the invention;

FIG. 4 is a bottom perspective view of a suspender coat harness with rear leg straps;

FIG. 3 is a top detail view of a suspender vest harness with pocket and reflector tape to aid visibility;

FIG. 2 is a front detail view of the suspender straps, criss-crossing diagonally at mid chest, and attached to the ribcage bands (a). and of the suspender straps attached to one side of the ribcage band, with the other side of the ribcage band ready to close on top (b); and

FIG. 5 is a perspective view of a suspender bikini harness.

For purposes of clarity and brevity, like elements and components will bear the same designations and numbering throughout the Figures.

### Description of the Preferred Embodiment

For purpose of clarity and brevity, like elements and components will bear the same designations and numbering throughout the Figures.

The following description of the preferred embodiment(s) is merely exemplary in nature and is no way intended to limit the invention, its application, or uses.

The present invention will become more fully understood from the detailed description and the accompanying drawings, wherein:

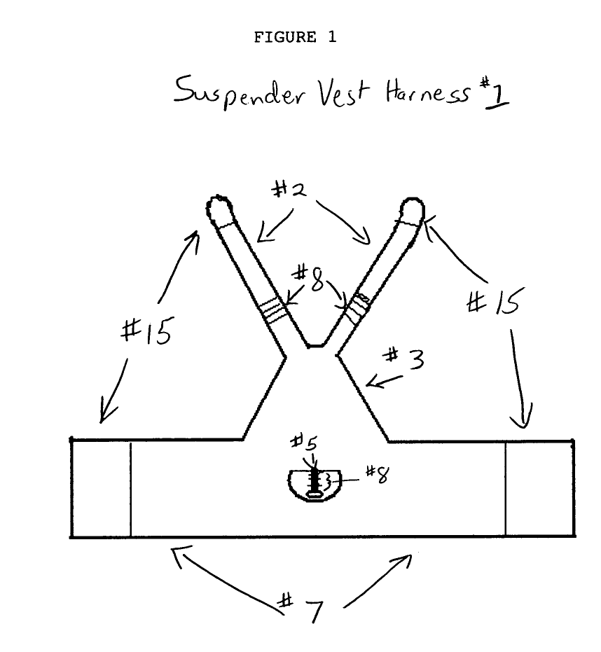

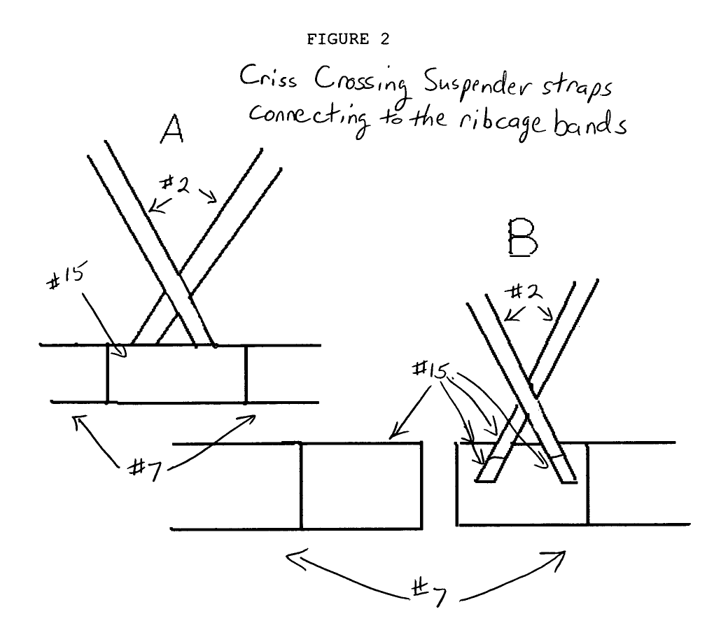

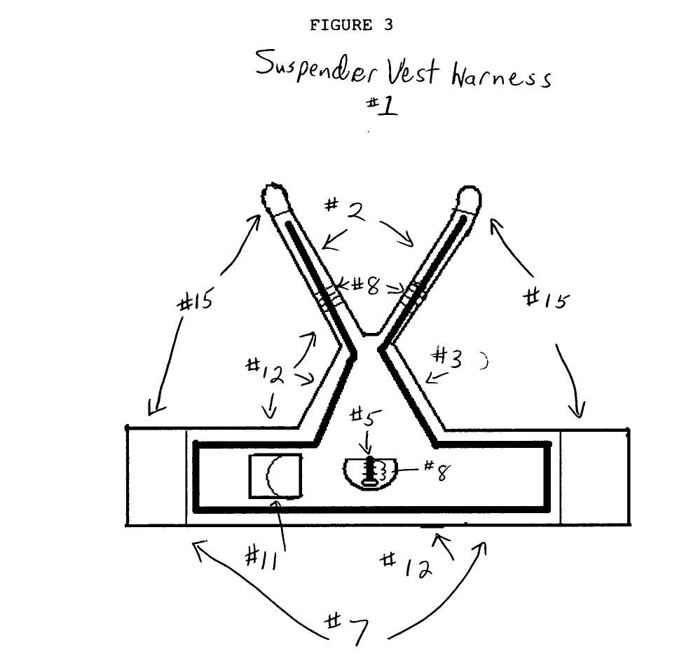

FIG. 1 is a perspective view of both the front and back sides of a suspender vest harness 1, as it's completely reversible, according to the principles of the present invention.

FIG. 2A is a front detailed view of the criss crossing right and left suspender straps 2 attached to the right and left sides of the ribcage band 7. bands.

FIG. 2B is a front detailed view of the right and left suspender straps 2 attached to one side of the ribcage band, with the other side ready to close on top and “sandwich” them in for a very secured closure.

FIG. 3 is a front detailed view of a suspender vest harness 1 with a pocket 11 to hold things and reflector tape 12 to aid visibility.

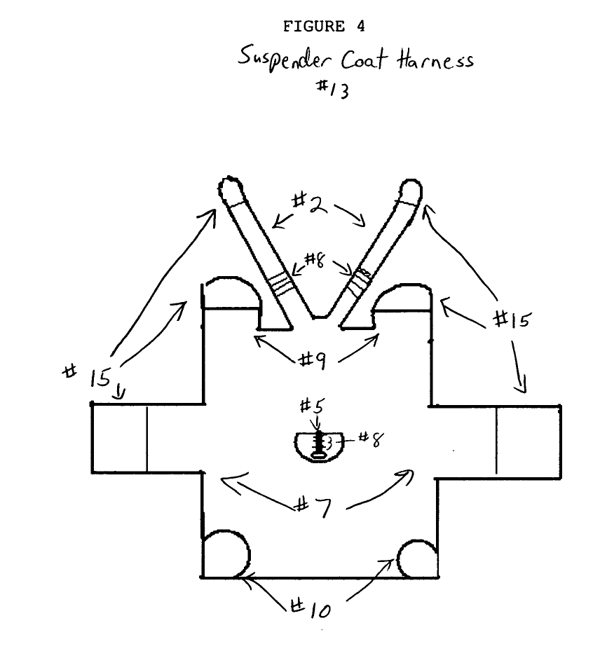

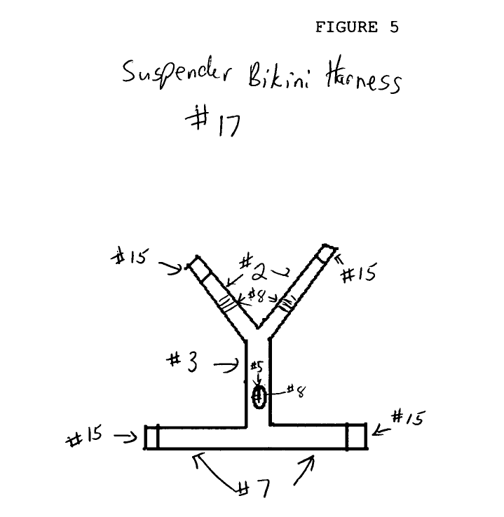

FIG. 4 is a bottom detail view of a suspender coat harness 13 showing the right and left front flaps 9 and right and left rear leg straps 10.

FIG. 5 is a perspective view of the front and back of a suspender bikini harness 17.

Most conventional harnesses on the market today, basically have narrow independent ribcage and neck straps, which are connected by a third strap, either on the top or on the bottom of the animal. The front strap entirely encircles the neck of the animal, and the back strap, entirely encircle the ribcage. If the third strap is on the top, the ring for the leash is attached to it, and when the animal pulls against a leash, tether, and/or lead, the ribcage strap and the third strap are pulled backwards, causing the neck strap to rise up, putting pressure on the throat. If the third strap is on the bottom, the ring is attached to the ribcage strap, so when the animal pulls, the ribcage strap slides backward, the third strap goes forward enabling the neck strap to ride up the throat applying pressure as well. Because an animal does not have a collarbone in the front like humans do to protect their throats, this usually results in the animal coughing, without any injury, and they stop pulling. However, if the pull or jerk is strong enough, serious, maybe even permanent injuries to the throat may occur.

There is a vest harness design that replaces the three narrow straps with a vest, to help dissipate the force over a larger surface area. However, it too has a front strap that entirely encircles the neck, and rides up the throat when pulled against, causing the same results as mentioned above. Also, the front straps are releasably secured to the animal with Velcro. R.T.M., in the front, and tend to come apart when the animal continues to pull forward, leaving only the ribcage band connected.

The answer to preventing neck and throat injuries, is the suspender vest harness 1 which is ergonomically designed, such that the front straps do not entirely encircle the animal's neck. Instead, the right and left suspender straps 2 go over the shoulders, criss cross each other diagonally, about mid chest and attach to the right and left sides of ribcage band, on the opposite side from the shoulder they crossed, as seen in FIG. 2B. The suspender straps are sandwiched between the right and left sides of the ribcage band 7, as shown in FIG. 2A, resulting in a strong secured connection that will not pull loose. When the animal pulls against the leash, tether, and/or lead, the bony structures of the ribcage, shoulder blades, and chest absorb all of the force. The right and left suspender straps 2 and the connecting strap 5 have elastic 8 sewn in, to further decrease the amount of force on the animal and with wider right and left sides of the ribcage band 7, mid portion 3, and right and left suspender straps 2 then the traditional harnesses mentioned above, any remaining forces are dissipated over a larger surface area as shown in FIGS. 1-4. On the end of both sides of, each the right and left suspender straps 2, and on the end of both sides of each the right and left sides of the ribcage band 7, are wide and long hook and loop fasteners 15. These fasteners 15 and the elastic 8 in the suspender straps, allow for a great range of adjustability. As seen in FIGS. 1, 3-5, the suspender vest harness 1, the suspender coat harness 13, and the suspender bikini harness 17 do not interfere with the excretory functions as they do not cover the penis or anal areas, thus the garment will not be soiled. Additionally, the suspender straps do not go over the head, making it easier for the owner to put on the animal. Together, all of these features provide increased safety, added comfort and fit, and protection from the elements in one garment.

A suspender vest harness 1 according to the preferred embodiment of the present invention as seen in FIGS. 1,3, the suspender coat harness 13 and the suspender bikini harness 17 in alternate embodiments as seen in FIG. 4-5, are very durable and tear resistant, because its made with two layers of continuous fabric and/or material, except for the connecting strap 5, with seams on the outer edges only. Various materials can be used to form the first and second layers; for example, but not limited to cotton, cotton canvass, fleece, wool, faux sheepskin and/or fur, suede, leather or leatherette, nylon, polyester, etc. Additionally, the materials can be water repellant, water proof, and/or water repellant added thereto. Preferably, the stitching used throughout the suspender vest harness 1 and the suspender coat harness 13 is, invisible high strength and weather resistant thread. Stitching (not shown) can also be used to emboss a desired pattern, image, name of the animal and/or contact information for the owners. The right and left suspender straps 2 and the right and left sides of the ribcage band 7 are sized, and the materials chosen, to be appropriate for the intended size of the animal upon which the suspender vest harness 1 and the suspender coat harness 13 are to be utilized. The fasteners 15 can be made from a variety of materials, including but not limited to hook and loop, metal, polymers, tied, and the like. Note, if the garment is a reversible, the fasteners 15 are on both sides, so choose them accordingly, Further, the ring can be made by way of a, non limiting example of polymer or metal. All are sized to be appropriate to the intended size of the animal.

This design, is completely reversible as shown in FIGS. 1, 3-5, made possible by the connection strap opening 4 in the center, granting access to the connection ring from both sides. However, an alternate embodiment may not be reversible, and/or not be two layers, and/or not have elastic 8, and/or not have a connection ring, and/or not have a connection strap opening 4, and/or the connecting strap 5 may be sewn directly to the top of the suspender strap harness, and it will still be a suspender vest harness 1 that functions properly with the ergonomically designed criss crossing diagonal right and left suspender straps 2 as seen in FIGS. 2A-B.

Being reversible, it can be two completely different designs in one suspender vest harness 1. The two different sides, allows for style and function at the same time (i.e., decorative print on one side and a water repellent or resistant fabric on the other with a detachable hat, a bright and reflective color as shown in FIG. 3, with added lights on one side and elastic 8 loop (s) or pocket 11 (s) to hold batteries on the other side for increased visibility as shown in FIG. 3, a casual print on one side and a dressier print on the other, etc.). Being made with two layers, allows for something in the middle (i.e., padding, insulative, cooling, buoyant, and/or weighted material, etc.), either sewn in permanently or temporarily placed in via an opening in the seam of the ribcage band that is releasably secured. With this versatility, the suspender vest harness 1 can provide padding, warmth, cooling, buoyancy, and weights to train the animal physiologically. Further, decorative trim, (i.e. ribbons, bias tape, flowers, applications, etc.), and a pocket 11, as seen in FIG. 3, or multiple pockets to provide storage a storage area for such things a waste bags, keys, contact information, etc., may be added to one and/or both sides for embellishment and style.

The suspender vest harness 1, as shown in FIG. 1, has right and left suspender straps 2, a mid portion 3, and right and left sides of the ribcage band 7. The ribcage band is wide enough to cover the animal's mid back area and long enough to encircle the ribcage. Extending from the top of the ribcage band, is the mid portion 3, covering the upper back to the shoulders and midway down the ribcage. Right and left suspender straps 2 come off the top, which are long enough to go over the shoulders, criss cross each other diagonally at mid chest, and attach to the ribcage band on the opposite side from the shoulder they crossed (FIG. 2A-B), and wide enough to cover the tops of the shoulders and most of the chest. Both the right and left suspender straps 2 connect to, and are sandwiched between, the right and left sides of the ribcage band 7 (FIG. 2A-B), which releasably secures to the animal with fasteners 15, as exampled, a hook and loop design. On the top of the ribcage band (top center of animal's back), there is a connection strap opening 4, with a connecting strap 5, holding a D ring, sewn into the top, to connect a leash, tether, and/or lead, as shown in FIGS. 1, 3. Note, the ring is for convenience but not needed for the suspender vest harness 1 to function.

To make this design reversible, use hidden seams, and sew layer one to layer two inside out, leaving an opening in the ribcage seam to pull it through. Note, any glue product will work to hold the two layers together as there is no force placed on any of the edges, however, I do not recommend using it to attach the elastic 8 or the connecting strap 5 but to use invisible thread so the stitching won't show. To add elastic 8 to the right and left suspender straps 2, you need to leave a small opening in each of the two strap's seams, approximately where the straps cross the shoulder area of the animal. Cut two pieces of elastic 8, narrow enough to fit inside the straps, and as long as the length needed to cross over the shoulders of the animal. Insert elastic 8 into the seam opening, so it extends down towards the end of the straps, away from the garment. With the elastic 8 sandwiched between the two layers of fabric and/or material, use a zig zag top stitch and strong invisible thread to sew the top end of the elastic 8 down, approximately where the top of the shoulder blades will be. Now scrunch approximately two inches of the strap fabric and/or material, down the elastic 8 to allow for the stretch, and sew the other end as above. To make the full length of the right and left suspender straps 2 elastic 8, use this same method, but adjust the lengths of the elastic 8 and shoulder straps accordingly. Note, the shoulder straps do not need elastic 8 for this design to work, and any stitch or thread will work but won't be as neat or strong.

The final step in making the suspender vest harness 1, is to sew long, wide pieces of hook and loop fasteners 15 on both sides of each right and left suspender straps 2 and both sides of each the right and left sides of the ribcage band 7, along all four edges. Be sure to sew loops on one side of each of the right and left suspender straps 2 and hooks on each of the right and left sides of the ribcage band of one side of the garment, then vice a versa on the other side of the garment. Now, the right and left suspender straps 2 can connect to either one of the ribcage band sides first, as shown in FIG. 2B and then the other, to be sandwiched in between the two for a secured closure, as shown in FIG. 2A. This “sandwiched” process is repeated when the other side of the suspender vest harness 1 is on top, and allows for the reversibility of the suspender vest harness 1. Note, any fasteners 15 will work, but remember, the fasteners 15 are sewn on both sides of each of the right and left sides of the ribcage band 7 and both sides of each the right and left suspender straps 2, so use something that will not poke the animal for maximum comfort.

Now cut an opening thru both layers of the garment, approximately in the top center of the ribcage band, as shown in FIG. 1, to allow for the connecting strap 5 and ring to be sewn into the garment. For aesthetic purposes, this connection strap opening 4 should be geometrical and neat. To make an elastic 8 connection strap, cut a piece of layer one and layer two, approximately three times the length you want the connection strap to be and approximately one and one half the width of the opening of the D-ring (or any other strong connecting device) that you intend to use. Now place the front sides of both layer one and layer two together, sew them along the two outer edges, and pull one end thru until both of the front sides of the two layers show. Then insert a piece of elastic 8 narrow enough to fit inside and approximately twice the length you want the connecting strap 5 to be. With the elastic 8 sandwiched between the two layers, sew one end, using a zig zag top stitch with strong thread. Note, invisible thread is not needed here because the stitching will not show. Then scrunch the fabric down the elastic 8 to allow for stretching and sew the other end using the same method. This, like the suspender straps described above, allows for the connecting strap 5 to be stretched when the animal pulls against the leash, tether, and/or lead. Note, this strap does not need the elastic 8 to work. Now place the connecting strap 5 thru the ring, bring each end of the connecting strap 5 together, and sew it into the top of the connection strap opening 4. For added strength, use any of the multiple seam reinforcement products. Note, a ring is not needed but is very convenient. Now sew the remaining edges of the circle closed. For style and decoration, add trim by using two different colors of bias tape (ribbon, or any other decorative material of your choice), matching each of the two different layers, respectively, and sew them around the remaining edges of the connection strap opening 4, instead of sewing the edges together. Invisible or matching colored thread should be used so the stitching does not show. However, any thread or glue products may be used.

To make this garment completely reversible, the connection strap must be made in a different way then above. Add one fourth of an inch to the lengths of both layers one and layer two, and then cut them in half. Place one half of layer one and one half of layer two, back to back, and sew one end together. Repeat with the other two half's. Invert one of the sides so that, layer one is across from layer two. Now place them together, inside out, sew along the outer two edges, and pull one end thru until the front sides are showing. This is now a connecting strap 5, follow the instructions above to attach to the garment.

One can make this same reversible garment easier, by placing both the main garment pieces (layer one and layer two) and the two connecting strap 5 pieces (layer one and layer two), back to back, and sew around the edges, then follow the instructions above. For aesthetic purposes, use invisible thread or even any glue products will work because there is no pressure on the outer seams of the garment or the connecting strap 5. However, use something strong to attach the connecting strap 5 and the elastic 8 to the garment. Note, any thread will work.

The suspender vest harness 1 is designed to be utilized on an animal having a head, neck, a chest, a body, front legs, hind quarters, and a ribcage area, along the body between the front legs and hind quarters. As such, the suspender vest harness 1 can be used on a variety of different animals, in particular the smaller ones (i.e. tiny teacup, teacup, tiny toy, and toy), for example, but not limited to, dogs, cats, ferrets, guinea pigs, rabbits, iguanas, sheep, horses, and the like. Suspender vest harness 1 is designed to cover a portion of the animal's body from the chest, neck, shoulders, upper back and ending mid back. It should be appreciated, however, that the suspender vest harness 1 can be configured to provide additional, or lesser coverage for an animal, as shown in FIG. 4-5, with the suspender coat harness 13 and the suspender bikini harness 17. The suspender coat harness 13 is made and functions like the suspender vest harness 1 with the same features and ergonomically designed criss crossing suspender straps, with an elongated backside of the ribcage band, which extends to the hind quarters and around the sides of the animal, for additional coverage. Additionally, right and left front flaps 9 are added on the top front, and right and left rear leg straps 10 to the bottom rear, of the respective sides. They can either be permanently attached as a separate garment or releasably secured to the original suspender vest harness 1 design. For less coverage, this same criss crossing suspender bikini harness 17 design can be made with slimmer suspender straps and ribcage bands, as well as, a smaller mid portion 3 connecting the two on the top, as shown in FIG. 5.

The suspender vest harness 1 can be utilized to provide protection against and accommodate for the weather (i.e., rain, cold, snow, heat, etc.), and/or add a reflector tape 12 as seen in FIG. 3 (i.e. to protect animals from cars, traffic, hunters, and the like), and/or add buoyancy (to float, swim,etc.), and/or weights to physiologically train the animal, and/or provide contact information, and/or carry small items.

The description of this invention is merely exemplary in nature and variations that do not depart from the gist of the invention are intended to be within the scope of the invention. Thus it should be appreciated that such variations are not to be regarded as a departure from the spirit and scope of the invention.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. An ergonomic animal suspender harness vest for controlling leashed animals while providing a uniform pressure distribution and protection from various weather conditions, comprising:
means for absorbing and dissipating forces across bony structures only, and providing adjustability; and
means for releaseably securing the suspender vest harness around the ribcage after connecting to the suspender straps, dissipating forces, and providing for adjustibility, continuously interwoven to said means for absorbing and dissipating forces across bony structures only, and providing adjustability.

2. The ergonomic animal suspender harness vest in accordance with claim 1, wherein said means for absorbing and dissipating forces across bony structures only, and providing adjustability comprises a right and left suspender straps, having a fastener on the ends.

3. The ergonomic animal suspender harness vest in accordance with claim 1, wherein said means for releaseably securing the suspender vest harness around the ribcage after connecting to the suspender straps, dissipating forces, and providing for adjustibility comprises a right and left sides of the ribcage band, having a fastener on the ends.

4. An ergonomic animal suspender harness vest for controlling leashed animals while providing a uniform pressure distribution and protection from various weather conditions, comprising:
a right and left suspender straps, having a fastener on the ends, for absorbing and dissipating forces across bony structures only, and providing adjustability; and
a right and left sides of the ribcage band, having a fastener on the ends, for releaseably securing the suspender vest harness around the ribcage after connecting to the suspender straps, dissipating forces, and providing for adjustibility, continuously interwoven to said right and left suspender straps.

5. The ergonomic animal suspender harness vest as recited in claim 4, further comprising:
a connecting strap, for absorbing forces and holding the connecting ring for the leash to attach to the vet, threadably attached to said right and left sides of the ribcage band.

6. The ergonomic animal suspender harness vest as recited in claim 4, further comprising:
a right and left front flaps, for covering the sides and front part of the animal.

7. The ergonomic animal suspender harness vest as recited in claim 5, further comprising:
a right and left front flaps, for covering the sides and front part of the animal.

8. The ergonomic animal suspender harness vest as recited in claim 4, wherein said right and left suspender straps is elastic.

9. The ergonomic animal suspender harness vest as recited in claim 5, wherein said right and left suspender straps is elastic.

10. The ergonomic animal suspender harness vest as recited in claim 6, wherein said right and left suspender straps is elastic.

11. The ergonomic animal suspender harness vest as recited in claim 7, wherein said right and left suspender straps is elastic.

12. The ergonomic animal suspender harness vest as recited in claim 5, wherein said connecting strap is elastic.

13. The ergonomic animal suspender harness vest as recited in claim 6, wherein said right and left front flaps is a right and left front flaps having a fastener on the ends.

14. The ergonomic animal suspender harness vest as recited in claim 7, wherein said connecting strap is elastic.

15. The ergonomic animal suspender harness vest as recited in claim 7, wherein said right and left front flaps is a right and left front flaps having a fastener on the ends.

16. The ergonomic animal suspender harness vest as recited in claim 14, wherein said right and left front flaps is a right and left front flaps having a fastener on the ends.

17. The ergonomic animal suspender harness vest as recited in claim 9, wherein said connecting strap is elastic.

18. The ergonomic animal suspender harness vest as recited in claim 10, wherein said right and left front flaps is a right and left front flaps having a fastener on the ends.

19. The ergonomic animal suspender harness vest as recited in claim 11, wherein said connecting strap is elastic.

20. The ergonomic animal suspender harness vest as recited in claim 11, wherein said right and left front flaps is a right and left front flaps having a fastener on the ends.

21. The ergonomic animal suspender harness vest as recited in claim 19, wherein said right and left front flaps is a right and left front flaps having a fastener on the ends.

22. An ergonomic animal suspender harness vest for controlling leashed animals while providing a uniform pressure distribution and protection from various weather conditions, comprising:
an elastic right and left suspender straps, having a fastener on the ends, for absorbing and dissipating forces across bony structures only, and providing adjustability;
an elastic connecting strap, for absorbing forces and holding the connecting ring for the leash to attach to the vet;
a right and left sides of the ribcage band, having a fastener on the ends, for releaseably securing the suspender vest harness around the ribcage after connecting to the suspender straps, dissipating forces, and providing for adjustibility, threadably attached to said connecting strap, and continuously interwoven to said right and left suspender straps; and
a right and left front flaps, having a fastener on the ends, for covering the sides and front part of the animal.
